(19) United States
(12) Patent Application Publication
(10) Pub. No.: US 2026/0002579 A1
(43) Pub. Date: Jan. 1, 2026

(54) POWER-SHIFT TRANSMISSION FOR A MOTOR VEHICLE TRANSMISSION OF THE RANGE CHANGE TYPE

(71) Applicant: ZF Friedrichshafen AG, Friedrichshafen (DE)

(72) Inventors: Martin Dankesreiter, Passau (DE); Thomas Oberbuchner, Traunstein (DE); Michael Haas

(73) Assignee: ZF Friedrichshafen AG, Friedrichshafen (DE)

(21) Appl. No.: 18/880,766

(22) PCT Filed: Jul. 10, 2023
(86) PCT No.: PCT/EP2023/069014

§ 371 Date: Jan. 2, 2025

(30) Foreign Application Priority Data
Jul. 11, 2022 (DE) 10 2022 207 035.6

(51) Int. Cl. F16H 3/00; F16H 3/08; F16H 3/097

(52) U.S. Cl. CPC F16H 3/006; F16H 3/097; F16H 2003/008; F16H 2003/0811; F16H 2003/0826; F16H 2200/0017; F16H 2200/0043

(57) ABSTRACT

A powershiftable transmission has first, second, and third spur gear stages and first, second, and third shifting elements. A first spur gear is mounted rotatably on an input shaft and can be connected rotationally fixed to the input shaft by the first shifting element. The first spur gear meshes with a second spur gear on an output shaft coupled to a third spur gear. Fourth and fifth spur gears mesh together in the third spur gear stage. The fourth spur gear is on the input shaft and the fifth spur gear is on the output shaft. Actuating the second shifting element couples the input shaft to the output shaft. The third spur gear is rotationally fixed on a second input shaft and the second spur gear is mounted rotatably on the output shaft and can be connected to the output shaft by actuating the third shifting element.

### RELATED APPLICATIONS

This application claims the benefit under 35 U.S.C. §371 as a U.S. National Phase Application of application no. PCT/EP2023/069014, filed on 10 Jul. 2023, which claims the benefit of German Patent Application no. 10 2022 207 035.6 filed on 11 Jul. 2022, the contents of which are hereby incorporated herein by reference in their entireties

### FIELD OF THE DISCLOSURE

The invention relates to a powershiftable transmission for a motor vehicle transmission of the range-change type, comprising a drive input shaft, a first input shaft. a second input shaft, and an output shaft. wherein a first powershift element is provided by means of which the first input shaft can be coupled to the drive input shaft, wherein a second powershift element is provided by means of which the second input shaft can be coupled to the drive input shaft, wherein a first spur gear stage, a second spur gear stage, and a third spur gear stage are provided, such that in the first spur gear stage a first spur gear is mounted rotatably on the first input shaft and can be connected rotationally fixed to the first input shaft by means of a first shifting element, wherein the first spur gear meshes with a second spur gear which is arranged on the output shaft and is coupled to a third spur gear which is associated with the second spur gear stage, wherein associated with the third spur gear stage there are a fourth spur gear and a fifth spur gear which mesh with one another and of which the fourth spur gear is arranged on the first input shaft and the fifth spur gear is arranged on the output shaft, and wherein, when a second shifting element is actuated, the first input shaft and the output shaft are coupled to one another by way of the third spur gear stage. In addition, the invention relates to a range-change transmission, a motor vehicle drivetrain, an agricultural or communal utility vehicle and a method for operating a transmission.

### BACKGROUND

In agricultural or communal utility vehicles, and particularly in agricultural tractors, owing to the wide variety of applications, different driving ranges usually have to be provided, which in a motor vehicle transmission of such utility vehicle necessitates a wide spread between a slowest gear and a fastest gear. Furthermore, in a motor vehicle transmission of such a utility vehicle, it is usual that there are small increments between the individual gear steps, so that in combination with the wide spread there have to be a large number of gears. To be able to produce this large number of gears at acceptable cost, motor vehicle transmissions for agricultural or communal vehicles are often designed as range-change versions.

In most cases a motor vehicle transmission of such type usually consists of several transmission groups, often with a step or main group, a splitter group connected upstream or downstream from the step or main group, sometimes a range group usually downstream and often also a reversing group as well as a crawling gear group. The gear sequence of the motor vehicle transmission is determined by the main group, and depending on the gear ratios engaged, these are correspondingly influenced by the other transmission groups connected upstream and/or downstream. In some cases, a splitter group and a main group of such a motor vehicle transmission are designed to enable powershifting in order to be able, during the work of the utility vehicle currently in progress, to carry out a gearshift usually only in the splitter group and the main group under load, and therefore with a high level of comfort.

Thus, EP 2 916 044 A1 discloses a motor vehicle transmission of group design which is provided for use in an agricultural utility vehicle such as a tractor. In this case the motor vehicle transmission consists of a plurality of transmission groups, one of which is in the form of a dual-clutch transmission. This transmission group comprises two input shafts with their axes parallel to one another, with each of which a powershifting element is associated. In this case, by actuating the respectively associated powershifting element each individual input shaft can be coupled to a common drive input shaft, which at the same time is also the drive output shaft of a multi-stage transmission connected upstream from the transmission. Associated with the two input shafts are a number of spur gear stages which, by the selective actuation of associated shifting elements, can participate in a power flow and thereby in each case can produce a coupling of the associated input shaft to an output shaft of the transmission with an associated transmission ratio. Loose wheels of the spur gear stages are in each case mounted rotatably on the input shafts and can be fixed thereto by closing the respectively associated shifting element, whereas fixed wheels are positioned rotationally fixed on the output shaft. In this case each individual fixed wheel meshes with two loose wheels, so that two spur gear stages in each case are arranged axially in a wheel plane.

### SUMMARY

Starting from the above-described prior art, the purpose of the present invention is now to provide a powershiftable transmission characterized by compact structure and low production costs, and in which at the same time as many different gears as possible can be engaged.

This objective is achieved with a powershiftable transmission as disclosed herein in combination with its characterizing features. Advantageous further developments and embodiments will be apparent in light of the present disclosure. The present disclosure also relates to a motor vehicle transmission of range-change design comprising a transmission group in the form of a transmission. In addition, the present disclosure relates to a motor vehicle drivetrain for an agricultural or communal utility vehicle, as well as to an agricultural or communal utility vehicle. Finally, the present disclosure relates to a method for operating a powershiftable transmission.

According to the invention, a powershiftable transmission comprises a drive input shaft, a first input shaft, a second input shaft and an output shaft. In this case a powershift element is provided, by means of which the first input shaft can be coupled to the drive input shaft, and in addition a second powershift element is provided, by means of which the second input shaft can be coupled to the drive input shaft. Furthermore a first spur gear stage, a second spur gear stage, and a third spur gear stage, and a first shifting element, a second shifting element, and a third shifting element are provided, such that in the first spur gear stage a first spur gear is mounted rotatably on the first input shaft and can be connected rotationally fixed to the first input shaft by means of the first shifting element. The first spur gear meshes with a second spur gear, which is arranged on the output shaft and is coupled to a third spur gear which is associated with the second spur gear stage. In addition, a fourth spur gear and a fifth spur gear are associated with the third spur gear stage, which mesh with one another and of which the fourth spur gear is arranged on the first input shaft and the fifth spur gear is arranged on the output shaft. In this case, when the second shifting element is actuated, the first input shaft and the output shaft are coupled to one another by the third spur gear stage.

In the context of the invention, a “shaft”, in particular the drive input shaft, the first input shaft, the second input shaft, and the output shaft, is understood to be a rotatable component of the powershiftable transmission, by way of which a power flow can be produced between components, if necessary, by the simultaneous actuation of a corresponding powershift element or shifting element. The shaft concerned can connect components of the transmission to one another axially, radially, or even both axially and radially. Thus, the shaft can be present in the form of an intermediate component by means of which a particular component can be connected radially, for example. Furthermore, the shaft concerned can be made as a one-piece component, or it can be made of more than one part when the shaft consists of a plurality of shaft portions connected rotationally fixed to one another. Alternatively, or in addition, the individual shaft can be in the form of a solid shaft, a hollow shaft, or partly solid and partly hollow.

In the context of the invention “axial” means an orientation in the direction of a longitudinal central axis of the powershiftable transmission, parallel to which the rotation axes of rotatable components of the transmission, in particular such as the shafts and the spur gears are arranged. “Radial” is then understood to mean an orientation in the direction of the diameter of a respective rotatable component, in particular a shaft or a spur gear.

In the powershiftable transmission, the drive input shaft can be coupled respectively to each input shaft by means of two powershift elements. In this case, in its actuated state the first powershift element couples the drive input shaft to a first input shaft, while on the other hand closing the second rotation speed element couples the drive input shaft to a second input shaft. Between the input shafts and the common output shaft a plurality of spur gear stages are provided, which are designed, whether individually or even in combination with one another, to couple the input shaft concerned to the output shaft.

Thus, the powershiftable transmission according to the invention consists of two part-transmissions, each of which has an input shaft. By selective actuation of the shifting elements, to engage various gears the individual input shafts can be coupled to the output shaft, so that to obtain the individual gears in each case the shifting elements are actuated selectively and a corresponding power flow path via at least one of the spur gear stages is produced. By the additional actuation of the associated powershift element, the associated input shaft of the part-transmission concerned can also be coupled to the drive input shaft, so that ultimately the drive input shaft is coupled to the output shaft with the gear ratio defined by the gear that is engaged.

In this case, the ability of the transmission to be powershifted is achieved in that when a current gear is engaged in one of the part-transmissions, then when a pending gearshift is to be carried out into a higher or lower target gear, the target gear is pre-selected in the respective other part-transmission in that by actuating the shifting elements associated with the target gear the drive output shaft is already coupled to the input shaft of the other part-transmission. The ultimate gearshift is then carried out by switching over between the powershift elements, which can be done under load and therefore essentially without interrupting a traction force. Correspondingly, as regards the gear sequence the gears are distributed in alternation between the two part-transmissions, so that during the course of a sequential engagement of the gears of the transmission, it is always possible to shift between adjacent gears under load by switching between the powershift elements.

In the context of the invention, a “spur gear stage” consists of two spur gears which permanently mesh with one another. A spur gear can at the same time be part of two spur gear stages if the spur gear meshes at the same time with spur gears associated with two different spur gear stages. Particularly preferably, in the powershiftable transmission according to the invention, precisely three spur gear stages are provided between the input shafts and the output shaft in the form of the first spur gear stage, the second spur gear stage, and the third spur gear stage, although if necessary one or more further spur gear stages can respectively be arranged between one of the input shafts and the output shaft. In the context of the invention, moreover, a spur gear connected rotationally fixed to a particular shaft can be present as a separate spur gear rotationally fixed to the shaft, or a spur gear made integrally with the shaft concerned.

In the context of the invention, a “powershift element” is understood to mean a shifting element that can be shifted under load, so that the powershift element concerned, when actuated under load, i.e., when it is transmitting a torque, can produce a rotationally fixed connection between the components of the transmission directly connected to it. Thus, the first powershift element is provided in order, when actuated, to couple the first input shaft and the output shaft to one another, wherein the coupling can be produced under load. The second powershift element is designed, when actuated, to produce a coupling between the second input shaft and the output shaft, this also being possible under load.

In contrast, the first shifting element, the second shifting element, and the third shifting element are present in the form of shifting elements which, when actuated, in each case produce a rotationally fixed connection between the components directly connected to them but this does not have to be possible under load. Accordingly, the first, second, and third shifting elements can also be designed as powershiftable shifting elements but this is not necessarily required for the function of the powershiftable transmission. Thus, the first, second and third shifting elements are preferably designed as non-powershiftable shifting elements. Preferably, in the transmission according to the invention, besides the two powershiftable shifting elements precisely three further shifting elements in the form of the first, second and third shifting elements are provided. However, if in addition to the first spur gear stage, the second spur gear stage and the third spur gear stage one or more further spur gear stages are arranged between one of the input shafts and the output shaft, then in particular a further shifting element is associated with the further spur gear stage.

When the first shifting element is actuated the first spur gear is connected rotationally fixed to the first input shaft, wherein the first spur gear is mounted rotatably as a loose wheel on the first input shaft and always meshes with the second spur gear, which is positioned on the output shaft and therefore coaxially with the output shaft. The second spur gear is also coupled to the third spur gear, where in the context of the invention a coupling of the second spur gear to the third spur gear is understood to mean that the second and third spur gears cannot rotate independently of one another, but that rotations of the second spur gear and the third spur gear take place with a fixed rotation speed ratio. The third spur gear is in this case also associated with the second spur gear stage.

Furthermore, the third spur gear stage consists of the fourth spur gear and the fifth spur gear, these two spur gears permanently meshing with one another and the fourth spur gear being positioned on the first input shaft and therefore coaxially with it, whereas the fifth spur gear is arranged on the output shaft and is therefore coaxial with the output shaft. By closing the second shifting element the fourth spur gear and the fifth spur gear bring about a coupling of the first input shaft to the output shaft.

The invention is now based on the technical principle that the third spur gear is fitted rotationally fixed onto the second input shaft, whereas the second spur gear is mounted rotatably on the output shaft and can be connected rotationally fixed to the output shaft by means of the third shifting element. In other words, as a fixed wheel the third spur gear is permanently connected rotationally fixed to the second input shaft, while in contrast the second spur gear is provided as a loose wheel mounted on the output shaft. The third shifting element, when actuated, then connects the second spur gear rotationally fixed to the output shaft so that as a result the second spur gear and the output shaft rotate together.

Such a design of a powershiftable transmission has the advantage that owing to the rotationally fixed arrangement of the third spur gear on the second input shaft and the design of the second spur gear as a loose wheel mounted rotatably on the output shaft, in combination with the rotatable mounting of the first spur gear on the first input shaft several different power flow paths via the spur gears can be produced with a small number of shifting elements. Since by actuating the third shifting element, it is possible, by interaction with the simultaneous actuation of the respectively associated powershift element and if necessary the first shifting element, to create a direct power flow path from the input shaft concerned to the output shaft. In addition however, in the actuated state of the second powershift element and thus by leading the power flow via the second input shaft, by interaction between the first spur gear, the second spur gear and the third spur gear a power flow path to the first input shaft is created, by virtue of which, starting via the third spur gear stage, a gear ratio to the output shaft is made possible. In total, in that way a large number of different gears can be obtained with a small number of spur gear stages and shifting elements, so that the transmission according to the invention is characterized by low production cost and a compact structure.

Thus, with the transmission according to the invention four different gears between the drive input shaft and the output shaft can be engaged: a first gear is engaged between the drive input shaft and the output shaft when the first powershift element and the first shifting element and the third shifting element are closed. In that way a power flow path is produced via the drive input shaft to the first input shaft, from which the power flow then passes by way of the first spur gear stage to the output shaft.

For the engagement of a second gear between the drive input shaft and the output shaft, the second powershift element is then closed and the third shifting element is actuated. The result is that the power flow passes from the drive input shaft to the second input shaft and starting from there is guided via the second spur gear stage to the output shaft.

To engage a third gear between the drive input shaft and the output shaft, the first powershift element and the second shifting element are then closed, whereby a power flow path is produced from the drive input shaft to the first input shaft and from there the power flow passes via the third spur gear stage to the output shaft.

Finally, a fourth gear between the drive input shaft and the output shaft is engaged when the second powershift element is closed, and at the same time the first shifting element and the second shifting element are closed. Thereby, starting from the drive input shaft the power flow passes to the second input shaft and then, as a special feature, starting from the second input shaft the power flow and by way of the second spur gear stage and the first spur gear stage a power flow passes to the first input shaft, which is coupled to the output shaft by the third spur gear stage. Correspondingly, in the fourth gear a power flow passes from the second input shaft via the second spur gear stage, the first spur gear stage and finally the third spur gear stage to the output shaft. Since in this the spur gear stages and also shifting elements of the other gears are used, the low production cost and compact structure of the transmission according to the invention can be realized.

A sequential engagement between the gears can be carried out under load, so that the gears can be powershifted during gearshifts in accordance with the gear sequence. Thus, a change from the first gear to the second gear can be carried out since only a load transfer from the first powershift element to the second powershift element takes place because in both gears the third shifting element is actuated in each case. After the change to the second gear has been completed, the first shifting element can then be opened.

A downshift from the second to the first gear can also be carried out under load. To do this, in the engaged condition of the second gear and with the power flow passing via the second input shaft, the downshift is prepared for in that the first shifting element is actuated in addition to the third shifting element. Then, for the downshift, it is only necessary to switch between the two powershift elements, since the second powershift element is open and the first powershift element is closed.

Besides the downshift under load from the second gear to the first gear, a shift can be carried out under load to the higher, third gear for which purpose this upshift also is prepared for before the actual switching between the powershift elements. In this case, the second shifting element is actuated in addition to the third shifting element, and then the load transfer from the second to the first powershift element is carried out in that the second powershift element is opened and the first powershift element is then closed. After that, the third shifting element can then be opened.

Conversely, a downshift from the third gear to the second gear can be carried out under load by first operating the third shift element in addition to the second shift element when the third gear is engaged. The actual downshift is then carried out by opening the first powershift element and closing the second powershift element, whereby the second gear is engaged. The second shifting element can then be opened.

Finally, the upshift from the third gear to the fourth gear can be carried out if, in the engaged condition of the third gear, in preparation for the actual upshift the first shifting element is closed in addition to the second shifting element, and after that the actual upshift is carried out by opening the first powershift element and closing the second powershift element. For the downshift from the fourth gear to the third gear, in contrast, it is only necessary to switch between the powershift elements and then open the first shifting element.

According to an embodiment of the invention, a gear ratio between the first input shaft and the output shaft via the first spur gear stage corresponds essentially to a gear ratio via the second spur gear stage between the second input shaft and the output shaft. Thus, a gear ratio in the power flow path from the first input shaft to the output shaft by way of the first spur gear stage alone corresponds essentially to a gear ratio which is produced when a power flow path passes only via the second spur gear stage from the second input shaft to the output shaft. This has the advantage that gear ratios of the two spur gear stages when the two input shafts are coupled by means of the first spur gear stage and the second spur gear stage to a large extent cancel one another. In the fourth gear the result is that when the second input shaft is coupled to the output shaft via the second spur gear stage, the first spur gear stage and the third spur gear stage, only the gear ratio defined by the third spur gear stage is effective.

The fact that the gear ratio produced by the first spur gear stage and the gear ratio produced by the second spur gear stage correspond “essentially” means, in the context of the invention, that there is only a slight and indeed negligible difference between those gear ratios. Thus, in particular the spur gears of the first spur gear stage and the second spur gear stage on the input shaft side differ in their tooth numbers only by a few teeth, whereas on the output shaft side preferably a constant number of teeth is provided.

In a possible design of the invention, the drive input shaft is positioned axially offset relative to the first and second input shafts, wherein the drive input shaft is coupled via a fourth spur gear stage to a first intermediate shaft which is arranged coaxially with the first input shaft and can be connected rotationally fixed to the first input shaft by actuating the first powershift element. In addition, the drive input shaft is coupled by a fifth spur gear stage to a second intermediate shaft, which is arranged coaxially with the second input shaft, and can be brought into rotationally fixed connection with the second input shaft by actuating the second powershift element. Thus, in this case the common drive input shaft is axially offset relative to both the first and the second input shafts, with the drive input shaft permanently coupled to intermediate shafts each of which is associated with one of the input shafts and can be connected rotationally fixed to its associated intermediate shaft by closing the respectively associated powershift element. The drive input shaft is permanently coupled to its respective intermediate shaft by means of an associated spur gear stage.

In particular, the fourth spur gear stage is formed by two spur gears that mesh with one another, one of which is arranged rotationally fixed on the drive input shaft and one rotationally fixed on the first intermediate shaft. Likewise, the fifth spur gear stage is formed by two spur gears that mesh with one another, and one of which is arranged rotationally fixed on the drive input shaft and one rotationally fixed on the second intermediate shaft. In that way, the drive input shaft can be coupled to the two intermediate shafts in a suitable manner. Alternatively to the above design, however, in which the fourth and fifth spur gear stages are each formed by two associated spur gears, a common spur gear of the fourth and fifth spur gear stages can be arranged rotationally fixed on the drive input shaft, which at the same time meshes both with a spur gear provided rotationally fixed on the first intermediate shaft and with a spur gear provided rotationally fixed on the second intermediate shaft. In these cases, a gear ratio that defines the fourth spur gear stage in the power flow path from the drive input shaft to the first intermediate shaft differs from a gear ratio that corresponds to the fifth spur gear stage in the coupling of the drive input shaft to the second intermediate shaft

Alternatively however, in an axially offset arrangement of the drive input shaft relative to the two input shafts it would also be conceivable for two intermediate shafts to be arranged coaxially with the drive input shaft, and for the individual intermediate shafts to be able to be connected rotationally fixed to the drive input shaft by the respective associated powershift element and to the respective associated input shaft by way of a spur gear stage in each case.

In an alternative embodiment of the invention, the drive input shaft is arranged coaxially with one of the input shafts and can be connected rotationally fixed to that input shaft by actuating the associated powershift element, whereas the drive input shaft is coupled by a fourth spur gear stage and a fifth spur gear stage to an intermediate shaft, which is arranged coaxially with the other input shaft and can be brought into rotationally fixed connection with the other input shaft by actuating the powershift element associated with the other input shaft. In this case, therefore, the drive input shaft is coaxial with one of the input shafts so that closing the associated powershift element results in a rotationally fixed connection of the drive input shaft with that input shaft. In contrast, when the other powershift element is actuated the other input shaft is coupled to the drive input shaft since the other input shaft is connected rotationally fixed by means of the associated powershift element to an intermediate shaft which is coupled to the drive input shaft by way of a fourth spur gear stage and a fifth spur gear stage. Particularly preferably, the drive input shaft is in this case positioned coaxially with the second input shaft and can be brought into rotationally fixed connection with the second input shaft by closing the second powershift element, whereas the intermediate shaft is arranged coaxially with the first input shaft and can be connected rotationally fixed to the first input shaft by closing the first powershift element.

As a further development of the above embodiment, a spur gear of the fourth spur gear stage is arranged rotationally fixed on the drive input shaft and meshes with a spur gear which at the same time meshes with a spur gear of the fifth spur gear stage, the spur gear of the fifth spur gear stage being arranged rotationally fixed on the intermediate shaft. In that way, the fourth and fifth spur gear stages have a common spur gear, which on the one hand meshes with the spur gear arranged rotationally fixed on the drive input shaft, and on the other hand meshes with the spur gear arranged rotationally fixed on the intermediate shaft. In that way, the drive input shaft can be coupled to the intermediate shaft with a small number of spur gears by way of the two spur gear stages. Alternatively however, the fourth and fifth spur gear stages can each comprise two spur gears, wherein the spur gear of the fourth spur gear stage arranged rotationally fixed on the drive input shaft meshes with a spur gear which is connected rotationally fixed to a spur gear of the fifth spur gear stage, this spur gear of the fifth spur gear stage in turn meshing with the spur gear of the fifth spur gear stage that is arranged rotationally fixed on the intermediate shaft.

Preferably, in the above-mentioned variants the intermediate shaft concerned is made at least partially as a hollow shaft which is arranged axially overlapping with and radially surrounding the associated input shaft and which can be connected rotationally fixed to the associated input shaft by actuating the respectively associated powershift element. In particular, the intermediate shaft concerned is entirely in the form of a hollow shaft.

As an alternative to the aforesaid further development, the intermediate shaft is arranged axially alongside the associated input shaft and can be connected rotationally fixed thereto by actuating the associated powershift element. Preferably, in this variant the intermediate shaft is completely in the form of a solid shaft or is solid at least at a front end facing toward the input shaft concerned.

In a further possible design of the invention, the fourth spur gear is mounted rotatably on the first input shaft and can be connected rotationally fixed to the first input shaft by actuating the second shifting element, whereas the fifth spur gear is arranged rotationally fixed on the output shaft. Thus, in this case, in the third spur gear stage the fourth spur gear is mounted rotatably on the first input shaft whereas the fifth spur gear is arranged as a fixed wheel on the output shaft. Actuation of the second shifting element then produces a rotationally fixed connection of the fourth spur gear to the first input shaft. In the context of the invention, however, the structure of the third spur gear stage could also be reflected precisely, since the fourth spur gear is arranged as a fixed wheel rotationally fixed on the input shaft whereas the fifth spur gear is mounted rotatably as a loose wheel on the output shaft and is fixed to it by actuating the second shifting element.

In an embodiment of the invention, the first spur gear, the second spur gear, and the third spur gear are arranged axially in one plane, with the second spur gear meshing both with the first and with the third spur gear. In this case, the second spur gear is thus part of both the first spur gear stage and the second spur gear stage. In that way, an axially more compact structure of the powershiftable transmission can be produced and the production cost is reduced owing to the small number of spur gears. In principle, however, in the context of the invention, it would also be conceivable for a further spur gear to be mounted rotatably on the output shaft, which spur gear is connected rotationally fixed to the second spur gear and can be fixed to the output shaft together with the latter by the third shifting element, this further spur gear then meshing with the third spur gear.

In a further development of the invention, each individual powershift element is in the form of a frictional shifting element, in particular a wet-operating or dry-operating frictional shifting element. In that way, the coupling of the input shaft concerned to the drive input shaft can be made under load without problems. A design as a disk clutch can also be considered.

In accordance with a possible design of the invention, each individual shifting element is in the form of an interlocking shifting element, in particular an unsynchronized claw-type shifting element. This has the advantage that in its open condition the individual shifting element gives rise to no drag losses, or only very small drag losses, which improves the efficiency of the transmission according to the invention. As an alternative to a design as an unsynchronized claw shifting element, however, the individual shifting element could also take the form of a lock synchronization. Furthermore, in principle a design of one or more of the shifting elements as frictional shifting elements, in this case in particular disk shifting elements, can be considered.

The invention further relates to a motor vehicle transmission for an agricultural or communal utility vehicle, wherein the motor vehicle transmission consists of a number of transmission groups and correspondingly has a group configuration. In this case the transmission, which is designed in accordance with one or more of the aforesaid variants according to the invention, is one of the transmission groups.

In particular, the transmission designed in accordance with one or more of the aforesaid variants forms a main group of the motor vehicle transmission wherein the drive input shaft is coupled to a further, upstream transmission group. This further transmission group is in particular a splitter group and in this case particularly preferably a powershiftable splitter group. Also preferably, the output shaft of the transmission according to the invention is coupled to a differential gearset by means of which, either if it is a transverse differential torque can be distributed to the drive wheels of a drive axle, or if it is a longitudinal differential torque can be distributed to more than one drive axle. By a combination of the powershiftable transmission according to the invention with an upstream powershiftable splitter group, a powershiftable motor vehicle transmission can be produced if necessary. Alternatively, however, the transmission made in accordance with one or more of the aforesaid variants can also be used as a PTO transmission in a motor vehicle transmission designed in a group configuration, and in that case the motor vehicle transmission is in particular a transmission for an agricultural machine.

As another alternative, the transmission made according to one or more of the above variants can also be used alone or in combination with further transmissions as the motor vehicle transmission in a passenger car or a truck.

A further object of the invention is a motor vehicle drivetrain in which an aforesaid motor vehicle transmission according to one or more of the above-described variants is provided. A drive input side of this motor vehicle transmission, preferably the drive input shaft of a transmission group such as a splitter group provided on the drive input side, is permanently coupled to an upstream drive machine, in particular an internal combustion engine. Between them is provided in particular a torsion-fluctuation damper. However, a separator clutch can also be arranged between the upstream drive machine and the transmission group of the motor vehicle transmission provided on its upstream side, by means of which the transmission group on the drive input side and hence the motor vehicle transmission as a whole can be decoupled from the drive machine.

As already described, within the motor vehicle drivetrain the motor vehicle transmission is preferably coupled on the drive output side to at least one drive axle of the agricultural machine by way of an intermediate differential gearset. In this case, a drive axle can be permanently coupled to a drive output side of the motor vehicle transmission, whereas a further drive input shaft can be engaged only by actuating a separator clutch.

The invention also relates to an agricultural or communal utility vehicle, particularly preferably an agricultural tractor. The utility vehicle comprises a motor vehicle drivetrain according to one or more of the aforesaid variants. Alternatively, however, a motor vehicle drivetrain of the above type can also be provided in a working machine.

### BRIEF DESCRIPTION OF THE DRAWINGS

Advantageous embodiments of the invention, which are explained below, are illustrated in the drawings, which show:

FIG. 1: A schematic representation of a motor vehicle drivetrain of an agricultural utility vehicle;

FIG. 2: A schematic representation of the motor vehicle drivetrain in FIG. 1, shown in the area of a motor vehicle transmission;

FIG. 3: A schematic detailed view of a powershiftable transmission of the motor vehicle transmission in FIG. 2, corresponding to a first embodiment of the invention;

FIG. 4: An example shifting scheme for the powershiftable transmission in FIG. 3;

FIGS. 5 to 8: Schematic detailed views of the powershiftable transmission in FIG. 3, shown in various shift conditions;

FIGS. 9 to 11: In each case a schematic detailed view of a powershiftable transmission according to a respective further possible design of the invention.

### DETAILED DESCRIPTION

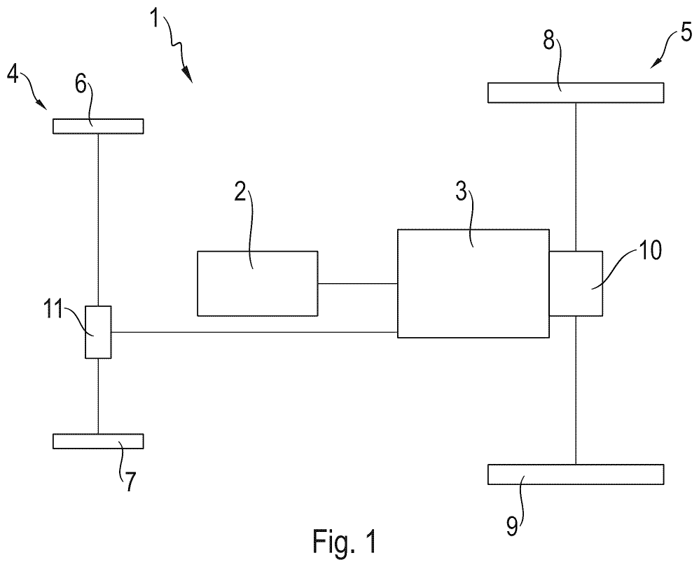

FIG. 1 shows a schematic view of a motor vehicle drivetrain 1 of an agricultural utility vehicle, which is preferably an agricultural tractor. The motor vehicle drivetrain 1 comprises a drive machine 2 which is in the form of an internal combustion engine and which, in the motor vehicle drivetrain 1, has a motor vehicle transmission 3 connected downstream from it.

In the motor vehicle drivetrain 1 there are in addition two drive axles 4 and 5, each having respective drive wheels 6 and 7 or 8 and 9. Associated with the drive axle 5 is a differential gearset 10 which, being a transverse differential, distributes an applied drive power to the two drive wheels while equalizing any rotation speed differences, if necessary. The differential gearset 10 is connected to the upstream motor vehicle transmission 3 and the differential gearset 10 can in this case be accommodated together with the motor vehicle transmission 3 in a common housing.

Apart from the differential gearset 10 the motor vehicle transmission 3 can be brought into connection on its drive output side with a differential gearset 11 on the drive axle 4, wherein in this case the connection can in particular be separated when required. When the connection is established, a drive power is transmitted to the differential gearset 11, if necessary. with equalization of the rotation speeds of the two drive wheels 6 and 7. Preferably, in this case the drive axle 4 is a front axle of the agricultural machine whereas the drive axle S is the rear axle of the agricultural machine.

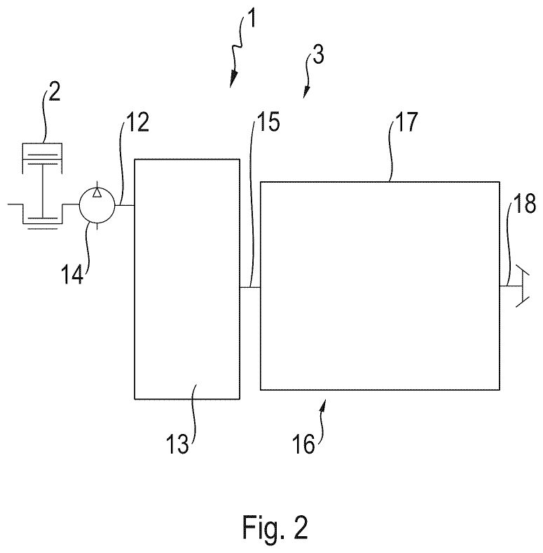

FIG. 2 shows a schematic representation of part of the motor vehicle drivetrain 1 in FIG. 1, in the area of the drive machine 2 and the motor vehicle transmission 3. As can be seen, the drive machine 2 is connected to a drive input shaft 12 of a powershiftable transmission group 13 of the motor vehicle transmission 3, and in this case a hydraulic pump 14 is also connected to the drive input shaft 12. The powershiftable transmission group 13 is a powershiftable splitter group of the motor vehicle transmission 3 and the transmission group 13 is also coupled via a drive output shaft 15 to a further transmission group 16 in the form of a transmission 17 which is also designed to be powershiftable. The transmission 17 is connected by way of an output shaft 18 within the motor vehicle drivetrain 1 shown in FIG. 1 to the downstream differential transmission 10. By virtue of the structure of the motor vehicle transmission 3 comprising the transmission groups 13 and 16, the motor vehicle transmission 3 is a group configuration.

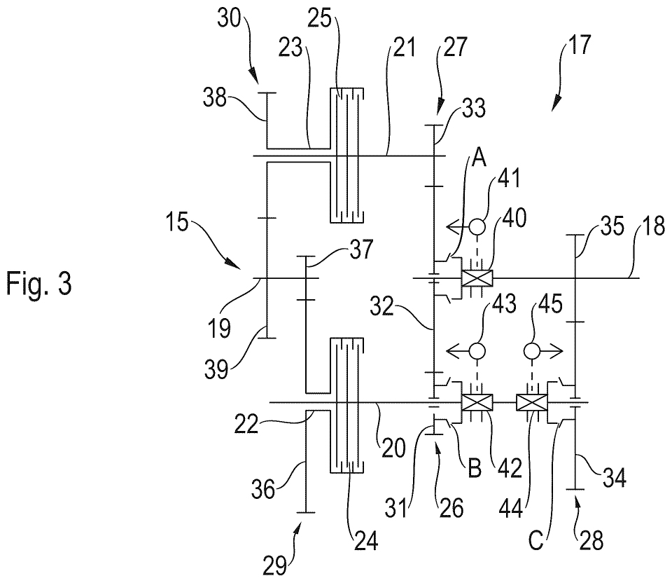

FIG. 3 shows a schematic detailed view of the transmission 17 such that in this case the transmission 17 is designed in accordance with a first embodiment of the invention. In the transmission 17 a drive input shaft 19 is arranged coaxially with the output shaft 18, the output shaft 18 at the same time also forming the drive output shaft 15 of the transmission group 13 upstream from the transmission 17 in the motor vehicle drivetrain 1. Correspondingly, the drive input shaft 19 is permanently coupled to the upstream transmission group 13.

Furthermore, the transmission 17 comprises two input shafts 20 and 21, which are positioned axially offset relative to the output shaft 18 and also relative to one another. An intermediate shaft 22 is also arranged coaxially with the input shaft 20, while an intermediate shaft 23 is arranged coaxially with the input shaft 21. Whereas the drive input shaft 19, the output shaft and the two input shafts 20 and 21 are made essentially as solid shafts, the two intermediate shafts 22 and 23 are hollow shafts. The intermediate shaft 22 axially overlaps the input shaft 20 and encloses it radially, while the intermediate shaft 23 axially overlaps the input shaft 21 and encloses it radially.

As can be seen in FIG. 3, in the transmission 17 two powershift elements 24 and 25 are provided, each of which is a frictional shifting element in the form of a wet-operating or dry-operating frictional shifting element. In this case, in its closed state the powershift element 24 produces a rotationally fixed connection between the input shaft 20 and the intermediate shaft 22, wherein the connection can be made under load and when there is a rotation speed difference between the input shaft 20 and the intermediate shaft 22. When it closes, the powershift element 25 connects the input shaft 21 rotationally fixed to the intermediate shaft 23, and this too can be done under load and when there is a rotation speed difference between the input shaft 21 and the intermediate shaft 23.

Furthermore, the transmission 17 also comprises a plurality of spur gear stages 26, 27, 28, 29 and 30 and shifting elements A, B and C. The spur gear stage 26 is formed by a spur gear 31 and a spur gear32 that meshes with the spur gear 31, wherein the spur gear 31 is mounted rotatably on the input shaft 20 whereas the spur gear 32 is mounted rotatably on the output shaft 18. The spur gear 32 is at the same time also part of the spur gear stage 27, since the spur gear 32, besides the spur gear 31, also meshes with a spur gear 33 and forms the spur gear stage 27 with it. In this case the spur gear 33 is arranged rotationally fixed on the input shaft 21. Consequently, the spur gear stage 26 and the spur gear stage 27 are arranged axially in one plane. In addition, the spur gear 31 and the spur gear 33 have essentially the same number of teeth so that a gear ratio defined by the spur gear stage 26 between the input shaft 20 and the output shaft 18 largely corresponds to a gear ratio defined by the spur gear stage 27 between the input shaft 21 and the output shaft 18.

The spur gear stage 28 consists of two spur gears 34 and 35 which mesh wit one another and of which the spur gear 34 is mounted axially close to the spur gear 31 and is mounted rotatably on the input shaft 20, whereas the spur gear 35 is arranged axially close to the spur gear 32 and is arranged rotationally fixed on the output shaft 18.

In the spur gear stage 29 two spur gears 36 and 37 are provided, which mesh permanently with one another. In this case the spur gear 36 is arranged rotationally fixed on the intermediate shaft 22 and the spur gear 37 is arranged rotationally fixed on the drive input shaft 19, so that the drive input shaft 19 and the intermediate shaft 22 are permanently coupled to one another by way of the spur gear stage 29. Likewise, by way of the spur gear stage 30 a permanent coupling of the drive input shaft 19 with the intermediate shaft 23 is produced since the spur gear stage 30 consists of two spur gears 38 and 39 that mesh permanently with one another, of which the spur gear 38 is arranged rotationally fixed on the intermediate shaft 23 and the spur gear 39 is arranged rotationally fixed on the drive input shaft 19.

The shifting elements A, B, and C are each in the form of interlocking shifting elements such that the individual shifting elements A or B or C are in particular in the form of unsynchronized claw shifting elements. The shifting element A is arranged coaxially with the output shaft 18 and in its closed state connects the spur gear 32 rotationally fixed to the output shaft 18. Consequently, the input shaft 21 is coupled to the output shaft 18 by way of the spur gear stage 27. To change it to its closed state the shifting element A comprises a coupling element 40 in the form of a sliding sleeve which, by means of an associated actuator 41 can be moved from a neutral position to a shift position in which the shifting element A is closed.

The shifting elements B and C are arranged coaxially with the input shaft 20 and the shifting element B, when closed, connects the spur gear 31 rotationally fixed to the input shaft 20. Thereby, the input shaft 20 is coupled to the input shaft 21 via the spur gear stages 26 and 27. If in addition the shifting element A is closed at the same time as the shifting element B, then the input shaft 20 is coupled to the output shaft 18 by way of the spur gear stage 26. The shifting element B also comprises a coupling element 42 in the form of a sliding sleeve, and this coupling element 42 can be moved by an actuator 43 from a neutral position to a shift position in which the coupling element 42 produces the closed state of the shifting element B.

In its closed state, the shifting element C connects the spur gear 34 rotationally fixed to the input shaft 20, which correspondingly results in a coupling of the input shaft 20 to the output shaft 18 by way of the spur gear stage 26. The closed state of the shifting element C can be produced by an associated coupling element 44 which for that purpose is moved from a neutral position to a shift position. That movement of the coupling element 44 from the neutral position to the shift position is produced by an actuator 45. The actuators 41, 43 and 45 of the shifting elements A, B and C are in particular controlled automatically by a transmission control unit of the transmission 17—not shown here—so that the shifting elements A, B and C are closed automatically. Likewise, the two powershift elements 24 and 25 are actuated automatically by the transmission control unit.

The spur gear stage 30 is positioned close to the connection of the transmission 17 to the transmission group 13 by means of the drive input shaft 19, so that axially after this first the spur gear stage 29, the spur gear stages 26 and 27 in one plane and finally the spur gear stage 28 are then arranged in sequence. The two powershift elements 24 and 25 are arranged axially at essentially the same level and are positioned axially between the spur gear stage 29 on the one hand and the spur gear stages 26 and 27 on the other hand. Moreover, the shifting elements A, B, and C are located axially between the spur gear stages 26 and 27 on the one hand and the spur gear stage 28 on the other hand, in such manner that the shifting elements A and B are provided axially essentially at the same level and axially close to the spur gear stages 26 and 27.

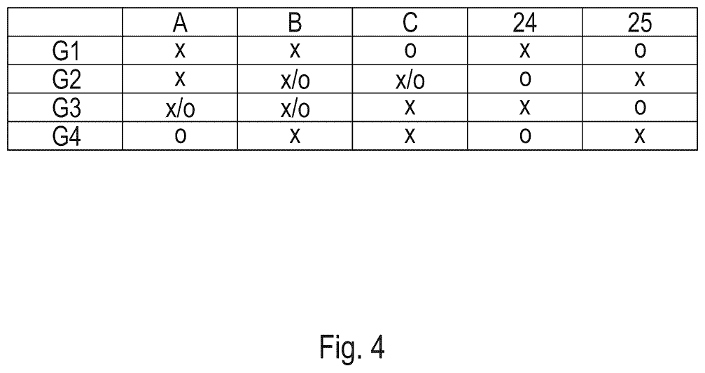

By means of the transmission 17, four different transmission ratios can be engaged as gears G1 to G4 between the drive input shaft 19 and the output shaft 18, the engagement of these gears being shown in the form of a table in FIG. 4. In the table, for the powershift elements 24 and 25 and for the shifting elements A, B, and C, an X indicates a closed state and an O indicates an open state, respectively. On the other hand, depending on the gear preselection X/O means a closed or open state of the shifting element A, B, or C concerned. As can also be seen from the table in FIG. 4, for the engagement of the gears G1 to G4 the powershift elements 24 and 25 are actuated in alternation, so that a sequential engagement of the gears G1 to G4 can be carried out in the manner of a dual-clutch transmission.

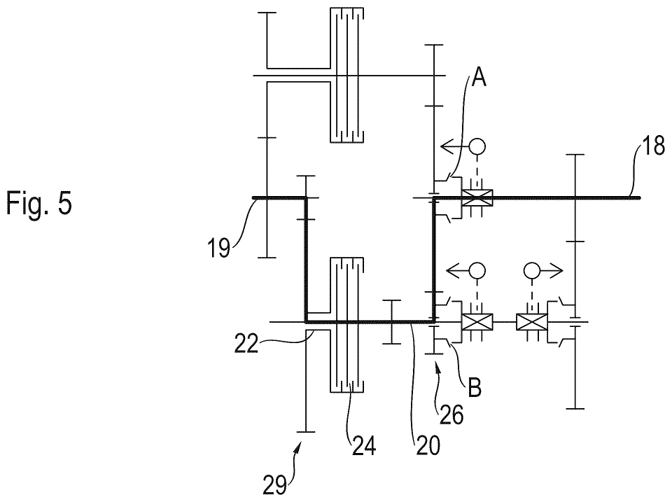

As can be seen in FIG. 4, the first gear G1 between the drive input shaft 19 and the output shaft 18 is engaged when the powershift element 24 and the shifting elements A and B are closed. In that way, starting at the drive input shaft 19 the power flow passes via the spur gear stage 26 to the intermediate shaft 22 and to the input shaft 20 connected rotationally fixed to the latter, starting from which the path continues via the spur gear stage 26 to the output shaft 18. The engaged state of the first gear G1 and the associated power flow path are shown in FIG. 5.

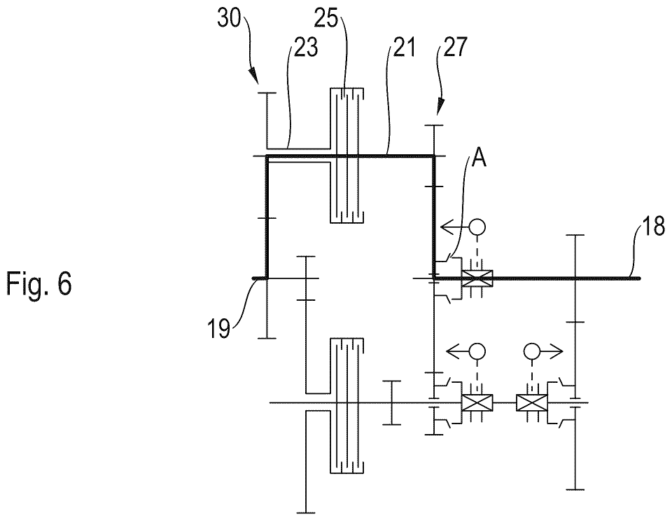

On the other hand, to engage the second gear G2, as can be seen in the table of FIG. 4, the powershift element 25 and the shifting element A must be closed. This results in the power flow path shown in FIG. 6, in which starting at the drive input shaft 19 the power flow passes via the spur gear stage 30 to the intermediate shaft 22 which is connected rotationally fixed to the input shaft 21 by the powershift element 25. From the input shaft 21 the power flow passes on via the spur gear stage 27 to the output shaft 18.

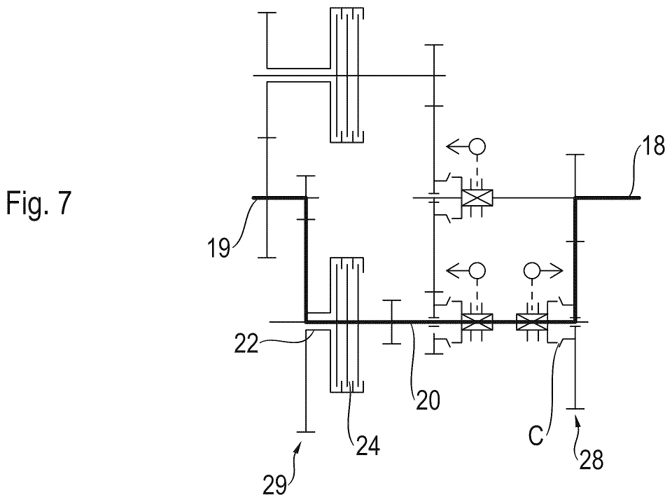

The third gear G3 is engaged by closing the powershift element 24 and the shifting element C, the engaged state and the associated power flow path in the third gear G3 being shown in FIG. 7. As can be seen, starting from the drive input shaft 19 in this case the power flow passes via the spur gear stage 29 to the intermediate shaft 22 and thus also to the input shaft 20 connected rotationally fixed thereto by the powershift element 24, and starting from the input shaft 20 the power flow path then continues onward via the spur gear stage 28 to the output shaft 18.

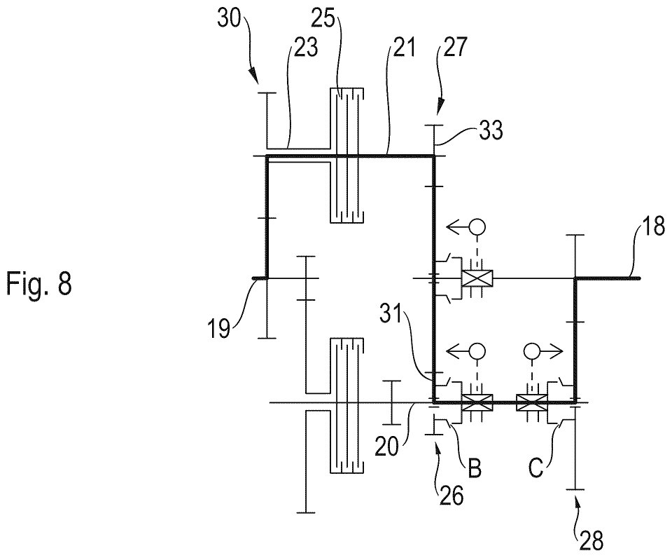

Finally, the fourth gear G4 between the drive input shaft 19 and the output shaft 18 is engaged by closing the powershift element 25 and the shifting elements B and C. In that way, starting from the drive input shaft 19 the power flow passes via the spur gear stage 30 to the intermediate shaft 23, which is connected rotationally fixed to the input shaft 21 by the powershift element 25. As a special feature, in the fourth gear G4 there is a further power flow path via the two spur gear stages 27 and 26 to the input shaft 20 and farther on via the spur gear stage 28 to the output shaft 18. Since the spur gears 31 and 33 have essentially the same number of teeth, the transmission ratios of the spur gear stages 26 and 27 when transmitting the rotation movement from the input shaft 21 to the input shaft 20 largely cancel out. The power flow path in this case is shown in FIG. 8.

A sequential engagement between the gears G1 to G4 is in this case possible with no interruption of the traction force, since in the current engaged state of the respective current gear and before the actual gearshift to the subsequent target gear, a preselection of the target gear is carried out, if necessary by appropriate actuation of the shifting elements participating in that gear, and the actual gearshift is then completed just by switching between the powershift elements.

Thus, a change from the first gear G1 to the second gear G2 can take place under load in that only a load transfer from the powershift element 24 to the powershift element 25 is needed, since in both gears the shifting element A is actuated. After the shift to the second gear G2 has been completed, the shifting element B can then be changed to its open state.

A downshift from the second gear G2 to the first gear G1 can also be carried out under load. For that purpose, in the engaged condition of the second gear G2 the downshift is prepared for by actuating the shifting element B in addition to the shifting element A and then, for the actual downshift, a switch-over is carried out from the powershift element 25 to the powershift element 24 by opening the powershift element 25 and then closing the powershift element 24.

Besides downshifting to the first gear G1, from the second gear G2 a gearshift under load can also be carried out to the next gear up, the third gear G3, for which purpose this upshift too is prepared for before the actual switching between the powershift elements 24 and 25. For this the shifting element C is actuated in addition to the shifting element A and then the load transfer from the powershift element 25 to the powershift element 24 is carried out by opening the powershift element 25 and then closing the powershift element 24. After that, the shifting element A can be opened.

Conversely, a downshift from the third gear G3 to the second gear G2 under load can be carried out when with the third gear G3 engaged, in addition to the shifting element C the shifting element A is actuated. The actual downshift is then carried out by opening the powershift element 24 and closing the powershift element 25, whereby the second gear G2 is engaged. After that the shifting element C can be opened.

Finally, the upshift from the third gear G3 to the fourth gear G4 can be done in that in the engaged condition of the third gear G3, to prepare for the actual upshift, in addition to the shifting element C the shifting element B is also closed, and after that the actual upshift is carried out by opening the powershift element 24 and closing the powershift element 25. For the downshift from the fourth gear G4 to the third gear G3, in contrast, it is only necessary to switch over between the powershift elements 24 and 25 and then open the shifting element B.

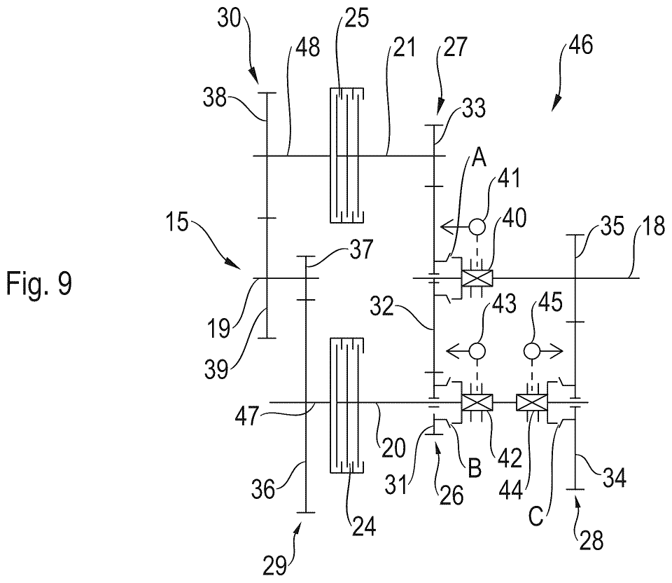

FIG. 9 shows a schematic view of a powershiftable transmission 46 designed in accordance with a second possible design of the invention and in which the motor vehicle transmission 3 from FIGS. 1 and 2 can be used as the transmission group 16 instead of the transmission 17. The transmission 46 corresponds essentially to the transmission 17 in FIG. 3, but the transmission 46 differs from the transmission 17 in that the intermediate shafts 47 and 48 are in this case in the form of solid shafts. The intermediate shaft 47 is arranged coaxially with and at the front end of the input shaft 20, and the intermediate shaft 47 can be connected rotationally fixed to the input shaft 20 by closing the powershift element 24 and is coupled to the drive input shaft 19 by means of the spur gear stage 29. The intermediate shaft 48 is arranged coaxially with and at the front end of the input shaft 21 and can be connected rotationally fixed to the input shaft 21 by closing the powershift element 25. Furthermore, the intermediate shaft 48 is permanently coupled to the drive input shaft 19 by means of the spur gear stage 30. In other respects, the embodiment shown in FIG. 9 corresponds to the variant in FIG. 3, so that reference can be made to the description of the latter. As regards the shifting from gears G1 to G4, reference can be made to the description relating to FIG. 4.

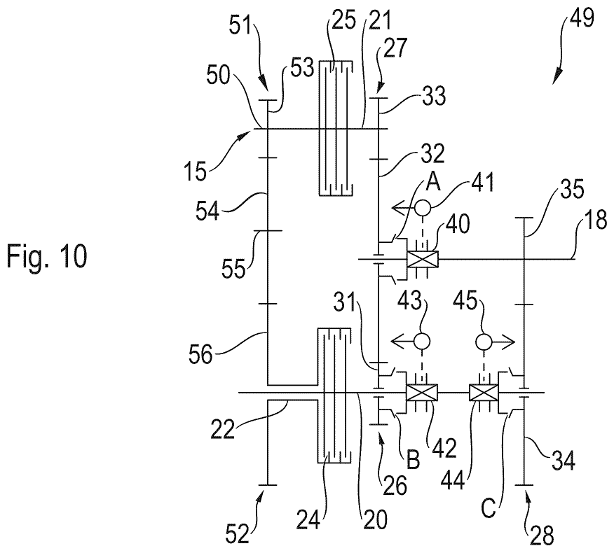

FIG. 10 shows a schematic representation of a powershiftable transmission 49 that corresponds to a further embodiment of the invention. The transmission 49 can also be used in the motor vehicle transmission 3 in FIGS. 1 and 2 as the transmission group 16 instead of the transmission 17 and corresponds essentially to the transmission 17 in FIG. 3. The difference in this case is that a drive input shaft 50 which within the motor vehicle drivetrain 1 forms the drive input side connection of the transmission 48 to the upstream transmission group 13 which is formed by drive output shaft 15 of the transmission group 13, is in this case arranged coaxially with the input shaft 21. By closing the powershift element 25 the drive input shaft 50 is correspondingly connected directly and rotationally fixed to the input shaft 21.

The drive input shaft 50 is coupled to the intermediate shaft 22 by two spur gear stages 51 and 52, wherein in the spur gear stage 51 a spur gear 53 is arranged rotationally fixed on the drive input shaft 50 and meshes with a spur gear 54 which is arranged rotationally fixed on a shaft 55. The spur gear 54 is also part of the spur gear stage 52 since besides the spur gear 53 it also meshes with a spur gear 56 which is arranged rotationally fixed on the intermediate shaft 22. In other respects, the embodiment according to FIG. 10 corresponds to the variant shown in FIG. 3, so that reference can be made to the description of the latter. As regards the engagement of gears G1 to G4, reference can again be made to the description relating to FIG. 4.

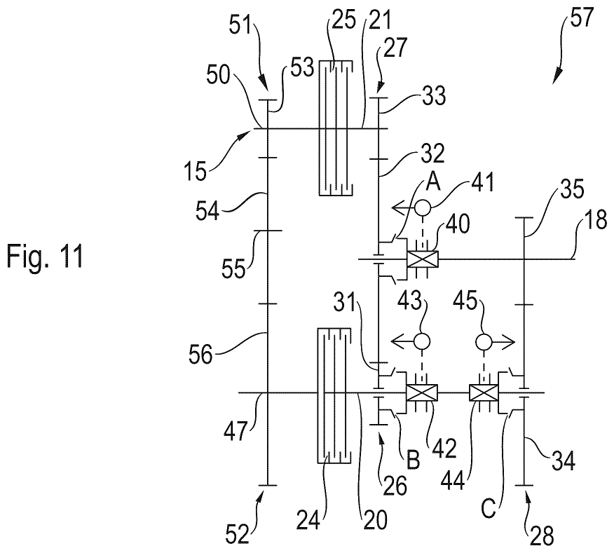

Finally, FIG. 11 shows a schematic view of a powershiftable transmission 57 according to a further possible design of the invention. This design option too can be used as an alternative to the transmission 17 in the motor vehicle transmission 3 shown in FIGS. 1 and 2, wherein in this case the transmission 57 corresponds in large measure to the variant shown in FIG. 10. The only difference this time is that an intermediate shaft 47 is now made as a solid shaft and is arranged coaxially with and at the front end of the input shaft 20. By closing the powershift element 24 the intermediate shaft 47 is connected to the input shaft 20. Furthermore, the spur gear 56 is mounted rotationally fixed on the intermediate shaft 47. In other respects, the design option according to FIG. 11 corresponds to the variant shown in FIG. 10, so that reference can be made to the description of the latter. As regards the engagement of gears G1 to G4, reference can again be made to the description relating to FIG. 4.

By virtue of the embodiments according to the invention, in each case a powershiftable transmission can be produced which is characterized by a compact structure and low production cost, and with which at the same time a large number of different gears can be engaged.

### Indexes

1 Motor vehicle drivetrain
2 Drive machine
3 Motor vehicle transmission
4 Drive axle
5 Drive axle
6 Drive wheel
7 Drive wheel
8 Drive wheel
9 Drive wheel
10 Differential gearset
11 Differential gearset
12 Drive input shaft
13 Transmission group
14 Hydraulic pump
15 Drive output shaft
16 Transmission group
17 Transmission
18 Output shaft
19 Drive input shaft
20 Input shaft
21 Input shaft
22 Intermediate shaft
23 Intermediate shaft
24 Powershift element
25 Powershift element
26 Spur gear stage
27 Spur gear stage
28 Spur gear stage
29 Spur gear stage
30 Spur gear stage
31 Spur gear
32 Spur gear
33 Spur gear
34 Spur gear
35 Spur gear
36 Spur gear
37 Spur gear
38 Spur gear
39 Spur gear
40 Coupling element
41 Actuator
42 Coupling element
43 Actuator
44 Coupling element
45 Actuator
46 Transmission
47 Intermediate shaft
48 Intermediate shaft
49 Transmission
50 Drive input shaft
51 Spur gear stage
52 Spur gear stage
53 Spur gear
54 Spur gear
55 Shaft
56 Spur gear
57 Transmission
A Shifting element
B Shifting element
C Shifting element
G1 First gear
G2 Second gear
G3 Third gear
G4 Fourth year

1. A powershiftable transmission (17; 46; 49; 57) for a motor vehicle transmission (3) configured as a group transmission, comprising:
a drive input shaft (19; 50);
a first input shaft (20);
a second input shaft (21);
an output shaft (18);
a first powershift element (24) configured to couple the first input shaft (20) to the drive input shaft (19; 50);
a second powershift element (25) configured to couple the second input shaft (21) to the drive input shaft (19, 50);
a first spur gear stage (26), a second spur gear stage (27) and a third spur gear stage (28);
a first shifting element (B), a second shifting element (C), and a third shifting element (A);
wherein in the first spur gear stage (26), a first spur gear (31) is mounted rotatably on the first input shaft (20) and can be connected rotationally fixed to the first input shaft (20) by means of the first shifting element (B);
wherein the first spur gear (31) meshes with a second spur gear (32) arranged on the output shaft (18) and which is coupled to a third spur gear (33) associated with the second spur gear stage (27);
wherein a fourth spur gear (34) and a fifth spur gear (35) are associated with the third spur gear stage (28), wherein the fourth spur gear (34) meshes with the fifth spur gear (35), the fourth spur gear (34) is arranged on the first input shaft (20), and the fifth spur gear is arranged on the output shaft (18); and
wherein the first input shaft (20) is coupled to the output shaft (18) by way of the third spur gear stage (28) when the second shifting element (C) is actuated; and
wherein the third spur gear (33) is arranged rotationally fixed on the second input shaft (21) whereas the second spur gear (32) is mounted rotationally fixed on the output shaft (18) and can be connected rotationally fixed to the output shaft (18) by means of the third shifting element (A).

2. The powershiftable transmission (17; 46; 49; 57) according to claim 1, wherein a transmission ratio that can be engaged by way of the first spur gear stage (26) between the first input shaft (20) and the output shaft (18) corresponds essentially to a transmission ratio engaged by way of the second spur gear stage (27) between the second input shaft (21) and the output shaft (18).

3. The powershiftable transmission (17; 46) according to claim 1, wherein the drive input shaft (19) is positioned axially offset relative to the first input shaft (20) and the second input shaft (21), wherein the drive input shaft (19) is coupled by way of a fourth spur gear stage (29) to a first intermediate shaft (22; 47) which is arranged coaxially with the first input shaft (20) and can be connected rotationally fixed to the first input shaft (20) by actuating the powershift element (24), and wherein the drive input shaft (19) is coupled by way of a fifth spur gear stage (30) to a second intermediate shaft (23; 48) which is arranged coaxially with the second input shaft (21) and can be brought into rotationally fixed connection with the second input shaft (21) by actuating the second powershift element (25).

4. The powershiftable transmission (17; 46) according to claim 3, wherein the fourth spur gear stage (29) is formed by two spur gears (36, 37) that mesh with one another, one of which is mounted rotationally fixed on the drive input shaft (19) and another of which is arranged rotationally fixed on the first intermediate shaft (22; 47), wherein the fifth spur gear stage (30) is formed by two spur gears (38, 39) that mesh with one another, one of which is mounted rotationally fixed on the drive input shaft (19) and another of which is arranged rotationally fixed on the second intermediate shat (23; 47).

5. The powershiftable transmission (49; 57) according to claim 1, wherein the drive input shaft (50) is arranged coaxially with one of the input shafts (20, 21) and can be connected rotationally fixed to the input shaft (21) by actuating the associated powershift element (25), wherein the drive input shaft (50) is coupled by way of a fourth spur gear stage (51) and a fifth spur gear stage (52) to an intermediate shaft (22; 47) which is arranged coaxially with the other input shaft (20) and can be brought into rotationally fixed connection with the said other input shaft (20) by actuating the powershift element (24) associated with the latter.

6. The powershiftable transmission (49; 57) according to claim 5, wherein a spur gear (53) of the fourth spur gear stage (51) is arranged rotationally fixed on the drive input shaft (50) and meshes with a spur gear (54) which at the same time meshes with a spur gear (56) of the fifth spur gear stage (52), wherein the spur gear (56) of the fifth spur gear stage (52) is arranged rotationally fixed on the intermediate shaft (22; 47).

7. The powershiftable transmission (17; 49) according to claim 3, wherein a respective intermediate shaft (22, 23; 22) is made at least partially as a hollow shaft which is arranged axially overlapping with and radially surrounding the associated input shaft (20, 21; 20) in each case, and can be connected rotationally fixed to the associated input shaft (20, 21; 20) by actuating the respectively associated powershift element (24, 25; 24).

8. The powershiftable transmission (46; 57) according to claim 7, wherein the respective intermediate shaft (47, 48; 47) is arranged axially adjacent to the associated input shaft (20, 21; 20) in each case, and can be connected rotationally fixed to the associated input shaft (20, 21; 20) by actuating the respectively associated powershift element (24, 25; 24).

9. The powershiftable transmission (17; 46; 49; 57) according to claim 1, wherein the fourth spur gear (34) is mounted rotatably on the first input shaft (20) and can be connected rotationally fixed to the first input shaft (20) by actuating the second shifting element (C), whereas the fifth spur gear (35) is arranged rotationally fixed on the output shaft (18).

10. The powershiftable transmission (17; 46; 49; 57) according to claim 1, wherein the first spur gear (31), the second spur gear (32), and the third spur gear (33) are arranged axially in one plane, and the second spur gear (32) meshes with both the first spur gear (31) and the third spur gear (33).

11. The powershiftable transmission (17; 46; 49; 57) according to claim 1, wherein individual powershift elements (24, 25) are in each case in the form of frictional shifting elements.

12. The powershiftable transmission (17; 46; 49; 57) according to claim 1, wherein individual shifting elements (A, B, C) are in the form of interlocking shifting elements.

13. A motor vehicle transmission (3) for an agricultural or communal utility vehicle, comprising a plurality of transmission groups (13, 16), one of which is the powershiftable transmission (17; 46; 49; 57) according to claim 1.

14. The motor vehicle transmission (3) according to claim 13, wherein the transmission group (16) in the form of the powershiftable transmission (17; 46; 49; 57) according to claim 1 is a main group and is coupled to the drive input shaft (19; 50) by an upstream splitter transmission group (13).

15. A motor vehicle drivetrain (1) for an agricultural or communal utility vehicle, comprising:
a plurality of transmission groups (13, 16), one of which is the powershiftable transmission (17; 46; 49; 57) according to claim 1 and is configured as a main group coupled to the drive input shaft by an upstream splitter transmission group.

16. An agricultural vehicle comprising:
a drivetrain comprising a plurality of transmission groups (13, 16), one of which is the powershiftable transmission (17; 46; 49; 57) according to claim 1 and is configured as a main group coupled to the drive input shaft by an upstream splitter transmission group.

17. A method for operating the powershiftable transmission (17; 46; 49; 57) according to claim 1, the method comprising:
engaging a first gear (G1) between the drive input shaft (19; 50) and the output shaft (18) when the first powershift element (24) and the first shifting element (B) and the third shifting element (A) are closed;
engaging a second gear (G2) between the drive input shaft (19; 50) and the output shaft (18) when the second powershift element (25) and the third shifting element (A) are closed;
engaging a third gear (G3) between the drive input shaft (19; 50) and the output shaft (18) when the first powershift element (24) and the second shifting element (C) are closed; and
engaging a fourth gear (G4) between the drive input shaft (19; 50) and the output shaft (18) when the second powershift element (25) and the first shifting element (B) and the second shifting element (C) are closed.
